(19) United States
(12) Patent Application Publication
(10) Pub. No.: US 2004/0138877 A1
(43) Pub. Date: Jul. 15, 2004

(54) Speech input apparatus and method

(75) Inventor: Masahide Ariu, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/742,907

(22) Filed: Dec. 23, 2003

(30) Foreign Application Priority Data
Dec. 27, 2002 (JP) 2002-382028

(51) Int. Cl. G10L 19/14

(52) U.S. Cl. 704/211

(57) ABSTRACT

A receiving unit receives a speech signal. A signal processing unit processes the speech signal. A memory stores environment information related to time. A time measurement unit measures a time. A control unit retrieves environment information related to the time from the memory, and controls the processing of the signal processing unit in accordance with the retrieved environment information.

### CROSS-REFERENCE TO RELATED APPLICATIONS

This application is based upon and claims the benefit of priority from the prior Japanese Patent Application P2002-340041, filed on Dec. 27, 2002; the entire contents of which are incorporated herein by reference.

### FIELD OF THE INVENTION

The present invention relates to a speech input apparatus and a method for always obtaining a suitable speech signal from an input speech in accordance with the user's environment situation.

### BACKGROUND OF THE INVENTION

Recently, because of improvements in electronic device circuits, information processing devices such as a Wearable Computer, Personal Digital Assistants (Hereinafter called PDA), and hand-held computers are widely used. In such devices, speech is an important factor in the interface between the device and a user.

Hereinafter, a general term used to describe an apparatus, a method, and a program in which speech is processed is called a “speech input system”. In various situations when the user uses the electronic device, suitable processing of speech and acquiring of clear speech are required for the speech input system to operate properly. For example, it is difficult for the presently used computer techniques to process the speech uttered by a person in a crowded or noisy room. Accordingly, it is necessary to suitably execute speech processing (signal processing) in various situations.

For example, when operating a PDA by speech recognition, characteristics of input speech from a silent office environment are different from characteristics of input speech from a crowded or noisy room. In this case, if the same speech processing algorithm is executed for both environments, sufficient operational ability often cannot be obtained. The signal-noise ratio (hereinafter, SN ratio) of speech varies between a silent environment and a noisy environment, and the user's speech method changes between a whisper and a loud voice. Accordingly, a speech processing system which adjusts to a change in the surrounding environment (for example, noise is suppressed by SN ratio of input speech or variations are eliminated by filtering the input speech) is necessary.

As a prior art solution, in general, adaptive signal processing is executed for input speech from every environmental situation (for example, “Advanced Digital Signal Processing and Noise Reduction”, chap.1, sec.3-1, and chap.6, sec.6; Saeed V. Vaseghi; September 2000 . . . reference (1)). Concretely, by arbitrarily estimating the surrounding noise and eliminating the noise effect from input speech, the noise can be suppressed for changes in the surrounding situation. Such adaptive signal processing is said to cope with every surrounding situation. However, it takes a long time for the system to adapt to the surrounding situation. Furthermore, transitory adaptive processing cannot cope when the change in the surrounding situation is large.

If an initial value of a parameter used to adjust to the surrounding situation for adaptive processing is supplied by a user or a high level system of the speech input system, the time to adapt to the surrounding situation is shortened and the error of processing is reduced. In general, the parameter for adjustment to the surrounding situation is useful for the speech input system. However, in the prior art, the operator of the speech input system decided the surrounding situation and set the signal processing adjustment according to the surrounding situation. Accordingly, the user's operation was sometimes troublesome and complicated processing was often necessary.

On the other hand, for the purpose of speech processing based on situation of use, time is often used to decide the situation. Specifically, a function of the system is changed based on the time of the speech input, and a recognizable speech (i.e., receivable speech) is determined by the function (For example, see Japanese Patent Disclosure (Kokai) PH8-190470, PP.1-5, FIG. 1 . . . reference (2)). However, in this reference (2), the surrounding environment of the system often cannot be decided by the time alone. Accordingly, signal processing based on information other than time cannot be performed.

Furthermore, sounds other than speech are often added based on the user's schedule. Specifically, from a view point of privacy protection, an environmental sound is generated and is multiplied with the voice inside a cellular phone and sent as a transmission (For example, see Japanese Patent Disclosure (Kokai) P2002-27136, PP.8-10, FIG. 10 . . . reference (3)). In this method, the main point is the protection of privacy for the user of the cellular-phone. For example, an environmental sound based on a user's daily schedule is multiplied with the user's voice. Thus the user's speech is not sent with a realistic sound of the user's surrounding during a telephone call. However, in the reference (3), the environmental sound (For example, a crowded room or train, a yard, an airport) is multiplied with the speech in the telephone call based on the user's schedule. However, the following problem may occur. If the schedule environment is an office, and the actual environment is a congested room, the other party to the telephone call hears the user's speech plus the noise of the office plus the noise of the congested room. If the actual environment is a stationary platform, the sound output to the other party is the user's speech plus the noise of the office plus the noise of the congested room. If the background sound of the actual environment is larger or more peculiar than the generated artificial sound, it often happens that the background sound dominates in what the other party hears.

### SUMMARY OF THE INVENTION

The present invention is directing to a speech input apparatus and a method for obtaining a clear speech signal by suitably processing the input speech in accordance with the environment related to the input time.

According to an aspect of the present invention, there is provided a speech input apparatus comprising: a receiving unit configured to receive a speech signal; a signal processing unit configured to process the speech signal; a memory configured to store environment information related to time; a time measurement unit configured to measure a time; and a control unit configured to retrieve environment information related to the time from said memory, and to control the processing of said signal processing unit in accordance with the retrieved environment information.

According to another aspect of the present invention, there is also provided a method for inputting a speech, comprising: storing environment information related to time in a memory; receiving a speech signal; measuring a time; retrieving environment information related to the time from the memory; determining a processing method to process the speech signal in accordance with the retrieved environment information; and executing the processing method for the speech signal.

According to still another aspect of the present invention, there is also provided a computer program product, comprising: a computer readable program code for causing a computer to input a speech, said computer readable program code comprising: a first program code to store environment information related to time in a memory; a second program code to receive a speech signal; a third program code to measure a time; a fourth program code to retrieve environment information related to the time from the memory; a fifth program code to determine a processing method to process the speech signal in accordance with the retrieved environment information; and a sixth program code to execute the processing method for the speech signal.

### BRIEF DESCRIPTION OF THE DRAWINGS

FIG. 1 is a block diagram of one component of a speech input system according to the present invention.

FIG. 2 is a flow chart of processing of the speech input system according to the present invention.

FIG. 3 is a block diagram of another component of the speech input system according to the present invention.

FIG. 4 is a block diagram of one component of a terminal including the speech input system of the present invention.

FIGS. 5A and 5B are schematic diagrams of examples of use of the speech input system.

FIG. 6 is a schematic diagram of the relationship between environment information and processing contents according to a first embodiment of the present invention.

FIG. 7 is a schematic diagram of the relationship between the environment information and the processing contents according to a second embodiment of the present invention.

FIG. 8 is a schematic diagram of the relationship between the environment information and a parameter according to a third embodiment of the present invention.

FIG. 9 is a flow chart of the processing of the speech input system according to a fourth embodiment of the present invention.

FIG. 10 is a schematic diagram of the relationship between the environment information and the parameter according to a fourth embodiment of the present invention.

FIG. 11 is a schematic diagram of the relationship between the environment information and the parameter according to a seventh embodiment of the present invention.

FIG. 12 is a schematic diagram of request and receiving of information between two speech input systems through a communication unit according to an eighth embodiment of the present invention.

FIG. 13 is a block diagram of one component of the speech input system according to a ninth embodiment of the present invention.

FIG. 14 is a schematic diagram of the relationship between the environment information and the parameter according to a ninth embodiment of the present invention.

FIG. 15 is a block diagram of one component of the speech input system according to a tenth embodiment of the present invention.

FIG. 16 is a block diagram of one component of the speech input system according to an eleventh embodiment of the present invention.

### DETAILED DESCRIPTION OF THE EMBODIMENTS

Hereinafter, various embodiments of the present invention will be explained by referring to the drawings.

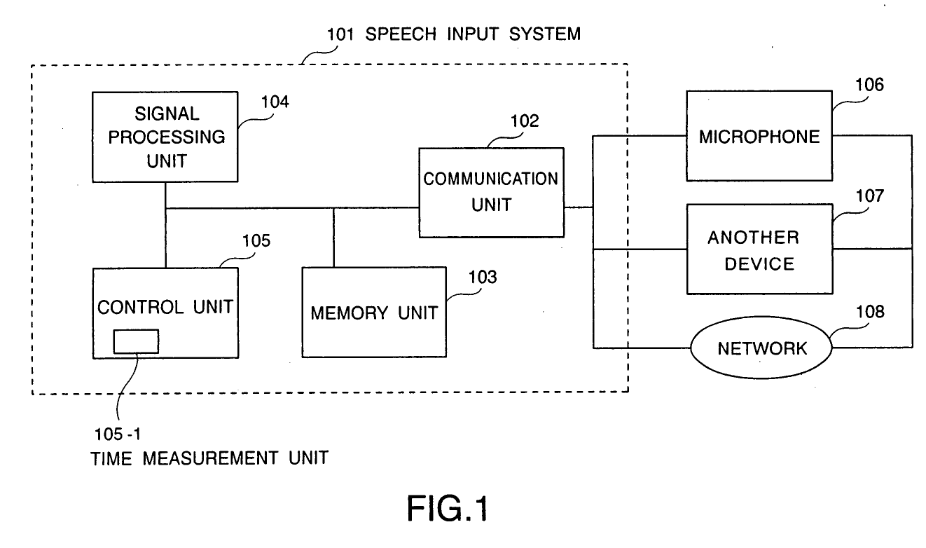

FIG. 1 is a block diagram of one component of the speech input system according to the present invention. In FIG. 1, the speech input system 101 includes following units. A communication unit 102 receives an input speech. A memory unit 103 stores a plurality of environment information and specific information corresponding to a different time. A signal processing unit 104 executes various kinds of signal processing such as noise reduction and speech recognition. A control unit 105 includes a CPU and controls the signal processing unit 104 based on the environment information stored in the memory unit 103. The control unit 105 includes a time measurement unit 105-1 (a clock means for measuring actual time or a count means for counting the passage of time). The time measurement unit 105-1 may obtain time information by receiving a time signal from outside the system such as an electronic wave clock. The time information may be relative time such as time passed from measurement start time or actual time, such as year-month-day-time.

A communication unit 102 connects with a microphone 106, another device 107 (such as information storage equipment, record/play equipment, a speech system), and a network 108 through a wired or a wireless connection. The communication unit 102 receives a speech input from the outside and sends a speech output to the outside. The communication unit 102 may include a function to convert data to a format suitable for processing by the signal processing unit 104.

As used herein, those skilled in the art will understand that the term “unit” is broadly defined as a processing device (such as a server, a computer, a microprocessor, a microcontroller, a specifically programmed logic circuit, an application specific integrated circuit, a discrete circuit, etc.) that provides the described communication and functionally desired. While such a hardware-based implementation is clearly described and contemplated, those skilled in the art will quickly recognize that a “unit” may alternatively be implemented as a software module that works in combination with such a processing device.

Depending on the implementation constraints, such a software module or processing device may be used to implement more than one “unit” as disclosed and described herein. Those skilled in the art will be familiar with particular and conventional hardware suitable for use when implementing an embodiment of the present invention with a computer or other processing device. Likewise, those skilled in the art will be familiar with the availability of different kinds of software and programming approaches suitable for implementing one or more “units” as one or more software modules.

In the processing result of the speech input system 101 is to be used by a circuit outside the speech input system 101, the signal processing unit 104 outputs the processing result under control of the control unit 105.

The microphone 106 converts the speech into a signal and transmits the signal. This microphone 106 can be any standard or specialized microphone. A plurality of microphones 106 may be set and controlled by a signal from the communication unit 102. For example, the microphone can be switched on and off or the direction of the microphone can be changed by a signal from the communication unit 102.

Another device 107 is a device for storing format information executable by the speech input system 101 and represents the device except for the speech input system 101. For example, assume that another device 107 is a PDA and stores a user's detailed schedule information. The control unit 105 of the speech input system 101 extracts executable format data of the schedule information from another device 107 through the communication unit 102 at an arbitrary timing. Furthermore, the control unit 105 requests another device 107 to send the executable format data at an arbitrary timing. In this case, the speech input system 101 can obtain environment information related to each time (For example, place information and person information as the user's schedule) without the user's direct input. A plurality of other devices may exist or another speech input system may replace another devise 107.

The network 108 may be wireless communication network such as Bluetooth or Wireless Local Area Network (Wireless LAN), or may be a large scale communication network such as Internet. The speech input system 101 can send and receive information with the microphone 106 and another device 107 through the network 108.

The memory unit 103 stores various kinds of environment information related to time. The environment information represents information which changes with time, information corresponding to predetermined periods, and functional information which changes over time (For example, schedule information). Accordingly, if situational change based on the passage of time is previously known, the environment information can be treated as the schedule information. If environment information does not correspond to time (For example, a sudden change in a situation or a positional change beyond a predetermined limit), the environment information is updated using sensor information.

Schedule information may include place information and person information (For example, a place where the user visits and a person who the user meets) related to time as an attribute. The environment information includes the surrounding situation of the speech input system 101 and the operational setting of the speech input system 101.

The memory unit 103 includes various areas to store a processing parameter for each environment situation, a temporary processing result, the speech signal and the output result. The memory unit 103 can be composed by an electronic element such as a semiconductor memory or a magnetic disk.

The signal processing unit 104 can process the speech signal from the communication unit 102 under control of the control unit 105 for the purpose of the speech input system 101. Briefly, the signal processing unit 104 executes signal processing using the environment information related to time. For example, the signal processing includes a noise reduction function, a speech emphasis function, and a speech recognition function. By extracting parameters necessary for signal processing from the memory unit 103, the signal processing unit 104 can then execute the signal processing using the extracted parameter. The signal processing unit 104 is created in software or may be an electronic element such as a signal processing chip.

The control unit 105 comprises a CPU and controls signal processing of the input speech in the signal processing unit 104 according to the environment information and the processing parameters stored in the memory unit 103. Furthermore, the control unit 105 controls operation of the speech input system 101.

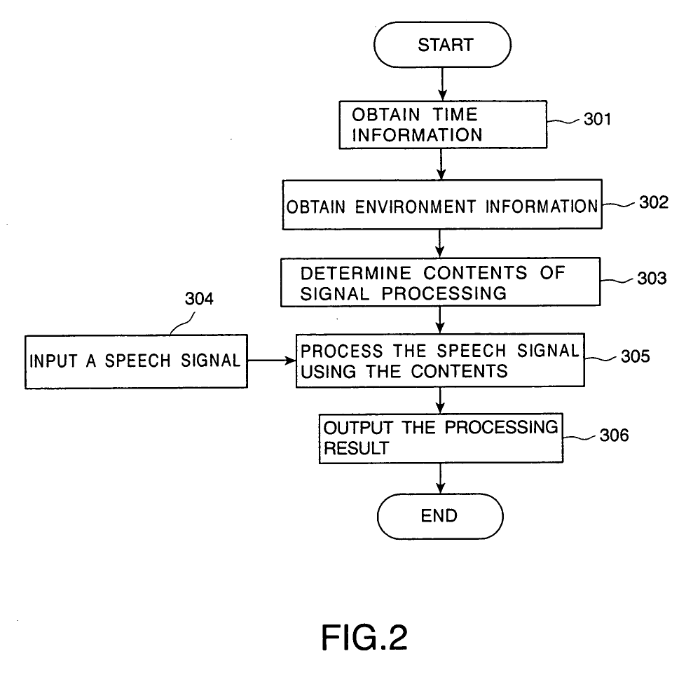

Next, operation of the speech input system 101 in FIG. 1 is explained by referring to FIG. 2. FIG. 2 is a flow chart illustrating processing of the speech input system 101 in FIG. 1. First, the control unit 105 obtains the current time as time information from the time measurement unit 105-1 (301). This time information may be obtained from another device 107 or another system (not shown in FIG. 1) through the network 108. Next, the control unit 105 obtains the environment information related to the present time from the memory unit 103 (302), and determines contents of the signal processing parameters of the input speech based on the environment information (303). Then, the signal processing unit 104 processes the input speech, and outputs the result to a predetermined area of the memory unit (304˜306). This memory area may or may not be present in the speech input system 101, and may exist outside the speech input system 101. In this case, address information of the environment information in the memory area is stored in the speech input system 101. If other environment information is necessary, the speech input system receives the environment information from outside the memory area by using the address information.

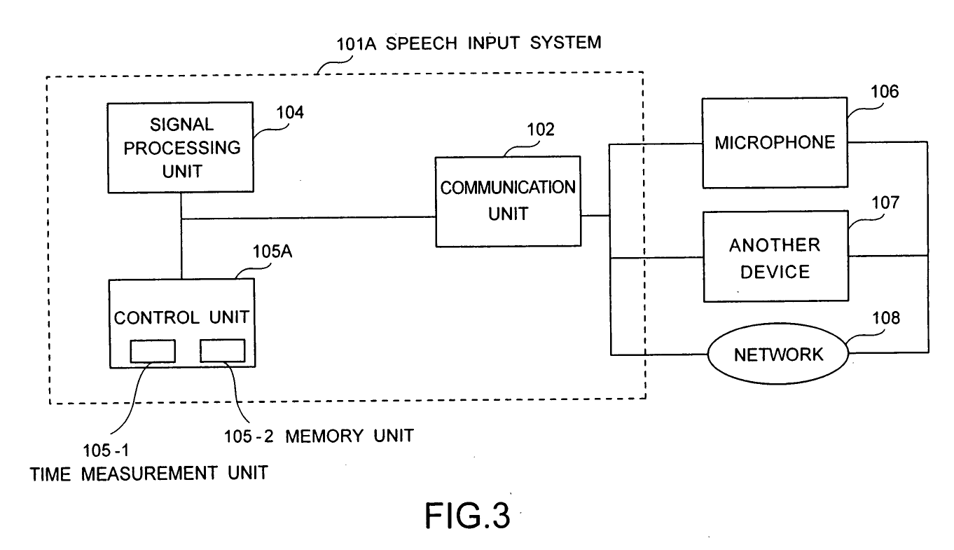

FIG. 3 is a block diagram of another component of the speech input system according to the present invention. In FIG. 3, the speech input system 101A includes following described units. A communication unit 102 receives an input speech. A signal processing unit 104 executes various kinds of signal processing such as noise reduction and speech recognition. A control unit 105A may be comprised of a CPU and controls the signal processing unit 104 based on environment information stored in a memory area of outside the system. The control unit 105A includes a time measurement unit 105-1 (a clock means for measuring actual time or a counter means for counting passage of time), and includes a memory unit 105-2 storing address information correlated to time to read the environment information from a memory area outside the system. In the component of FIG. 3, if the memory area storing the environment information related to each time exists outside the system, an address of the environment information in the memory area is stored in association with each time interval information in the memory unit 105-2. Accordingly, the address related to the time measured by the time measurement unit 105-1 is retrieved from the memory unit 105-2, and the environment information related to the address is retrieved from the outside. In this way, the control unit 105 controls processing of the signal processing unit 104 by use of the appropriate environment information. The processing operation of the speech input system 101A is the same as the flow chart of FIG. 2, and is thus omitted.

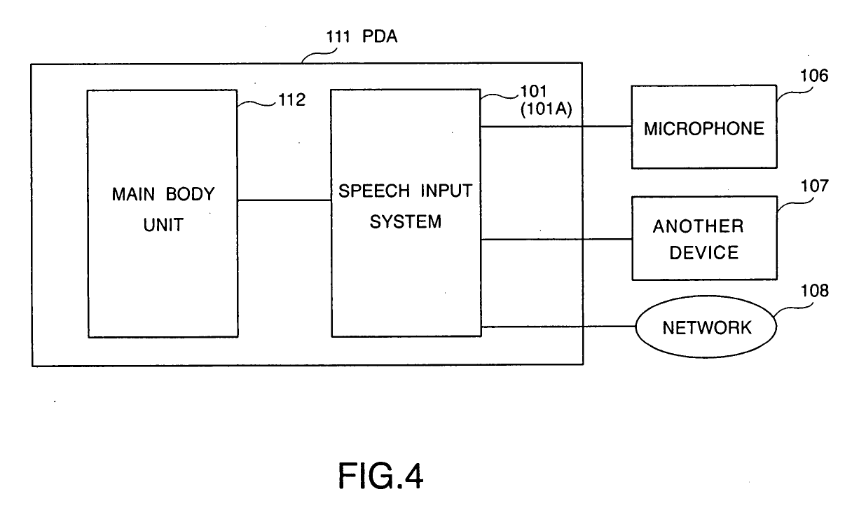

The above-mentioned speech input system 101 (101A) can be installed into a portable terminal such as PDA. FIG. 4 is a block diagram of a PDA 111 including the speech input system 101 (101A). In FIG. 4, PDA 111 includes the speech input system 101 (101A) and a main body unit 112. The speech input system 101 (101A) receives input of a speech through the microphone 106 and executes signal processing of the speech using the environment information as shown in FIG. 1. The main body unit 112 includes a user indication unit, a display unit, a data memory unit and a control unit (not shown in FIG. 4). The main body unit 112 creates a schedule table such as a calendar, holds, receives and sends a mail, receives and sends Internet information, and records and plays speech data processed by the speech input system 101. The capacity of the data memory unit in the main body unit 112 is larger than capacity of the memory unit 103 in the speech input system 101. Accordingly, the data memory unit in the main body unit 112 can store a large quantity of data such as image data, speech data and character data.

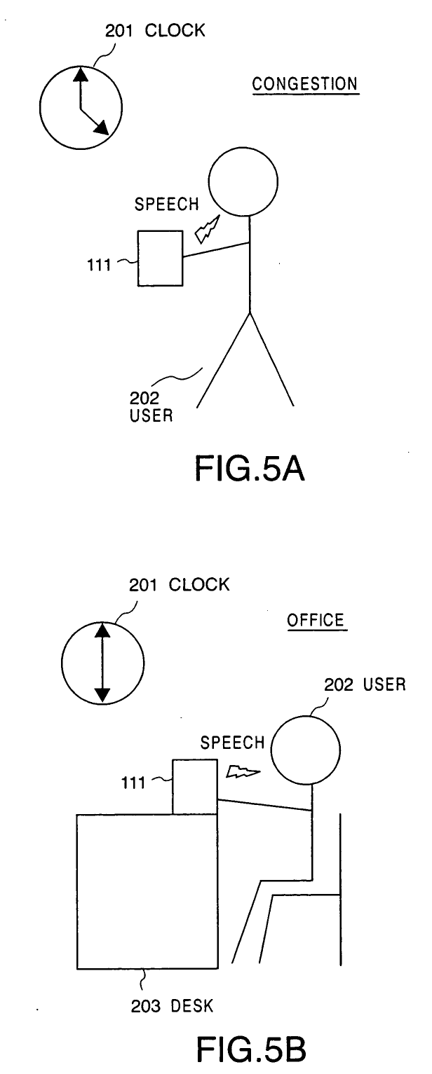

FIGS. 5A and 5B are schematic diagrams of use of the PDA 111 in FIG. 4 in different situations. In FIGS. 5A and 5B, a clock 201 represents a time and may not physically exist at the location of the user. In FIG. 5A, the clock 201 represents four o'clock in the afternoon. In FIG. 5B, the clock 201 represents six o'clock in the afternoon. As shown in FIG. 5A, user 202 is outside at four o'clock in the afternoon and the user 202 has the PDA 111, including the speech input system 101, in a crowded, congested area. Assume that the user 202 operates the PDA 111 by voice commands and the user's location as a crowded, congested area at four o'clock is recorded in the schedule table in the data memory unit of the PDA. In this case, the user 202 has previously set use of the schedule table stored in the main body unit 112 as environment information. Accordingly, the memory unit 103 obtains environment information related to time from the schedule table. In the speech input system 101 of the PDA 111, the control unit 105 obtains environment information from the memory unit 103. Briefly, information that the user 202 is out at this time is obtained. As the user inputs speech to the PDA 111, the control unit 105 reads a sound processing parameter and a processing method for crowded or congested locations from the memory unit 103. Accordingly, a suitable speech processing and correct speech recognition are executed for the speech. The control unit 105 makes the main body unit 112 of the PDA to operate based on the signal processing result. For example, by starting Internet receiving operation, the user's desired information can be obtained. Alternatively, the user's words can be recorded in the main body 112 as a speech memo. Furthermore, as shown in FIG. 5B, assume that the user 202 is in his or her office at six o'clock in the afternoon and operates the PDA by his/her voice as an instruction word. As discussed above, the control unit 105 of the speech input system 101 obtains information that the user 202 is in his or her office at this time, based on the environment information related to six o'clock stored in the memory unit 103. At the user's speech to the PDA 111, the control unit 105 reads a sound processing parameter and a processing method for the office located from the memory unit 103. Accordingly, suitable speech processing and correct speech recognition are executed for the words said in office. In this way, by using signal processing technique such as noise reduction, speech emphasis and speech recognition, suitable speech processing can be executed based on the user environment. Furthermore, in the case of executing adaptive signal processing, an adaptive parameter can be stored. In this case, at a latter time (For example, tomorrow), if information that the user is in the same office at six o'clock is obtained, the adapted parameter is read out and used for the speech processing. As a result, accurate speech processing can be simply executed.

The speech input system of the present invention can be applied to other terminal apparatus (for example, a cellular-phone, a recording equipment, a personal computer). Furthermore, the environment information is not limited to the schedule information only.

Next, the speech input system of the first embodiment of the present invention is explained. In this case, the speech input system 101 is used for speech input to the main body unit 112 in the PDA. Furthermore, in the main body unit 112 of the PDA, a speech signal from the speech input system 101 can be recorded as a speech memo in the data memory unit of the main body unit 112. The flow chart of processing of the speech input system of the first embodiment is the same as the flow chart of FIG. 2.

First, time information is obtained by the time measurement unit 105-1, and environment information (such as location) related to the present time is read from the memory unit 103. Next, contents of the signal processing parameters of the input speech are determined based on the environment information. Last, signal processing is executed for the input speech by the determined contents.

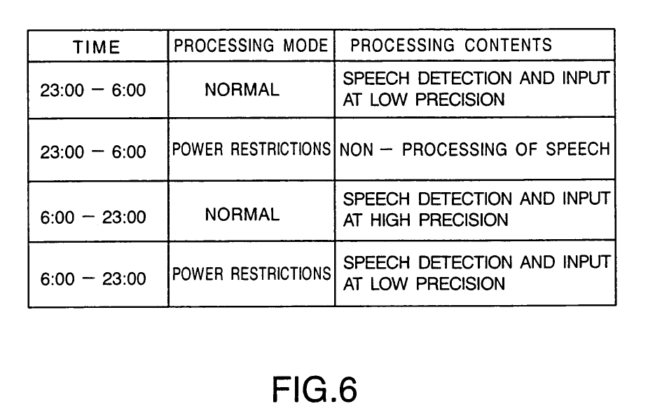

Next, determination of contents of the signal processing parameter is explained by referring to FIG. 6. FIG. 6 shows the relationship between the environment information and processing contents according to the first embodiment. In FIG. 6, a normal mode and a power restriction mode are available to the PDA 111, including the speech input system 101. These modes are regarded as environment information and different processing contents are stored based on the environment information. As shown in FIG. 6, “processing mode” is set to depend upon the environment information related to time, and “processing contents” is stored dependent upon the environment information.

Concretely, in the case of “normal” mode at ten o'clock, the possibility that the user inputs his/her speech during work time is high, and a power-saving is not necessary. Accordingly, a speech detection of high precision is executed for the input speech and a high precision result of speech detection is sent to the main body unit 112 of PDA as the processing result of the speech input system 101. Briefly, adequate speech processing based on the user's active situation is executed. This speech detection method can be realized as shown in (“Onkyo Onsei Kogaku” PP.177, S. Furui; Kindai Kagaku Inc., 1992, . . . reference (4)). Furthermore, signal extraction techniques to provide a high quality speech, as is available from a compact disk, exists in general. Accordingly, extraction of the input speech can be realized by these conventional techniques.

Next, in the case of “normal” mode at midnight or in the case of “power restrictions” mode at ten o'clock, a simple speech detection or a speech processing of low precision (For example, the sampling quality is telephone quality (8 KHz)) is executed. This is selected because the user seldom input his/her speech late at night or the PDA is set in the power restrictions mode.

Next, in the case of “power restrictions” mode at midnight, the speech processing is not executed. This is selected because the PDA has no electric power for processing and the user seldom input his/her speech at night time. In the case, the speech processing is not necessary or should not be executed. Furthermore, if environment information related to the current time is not stored, the contents of signal processing parameters may be previously determined or the contents of signal processing near the measured time may be used.

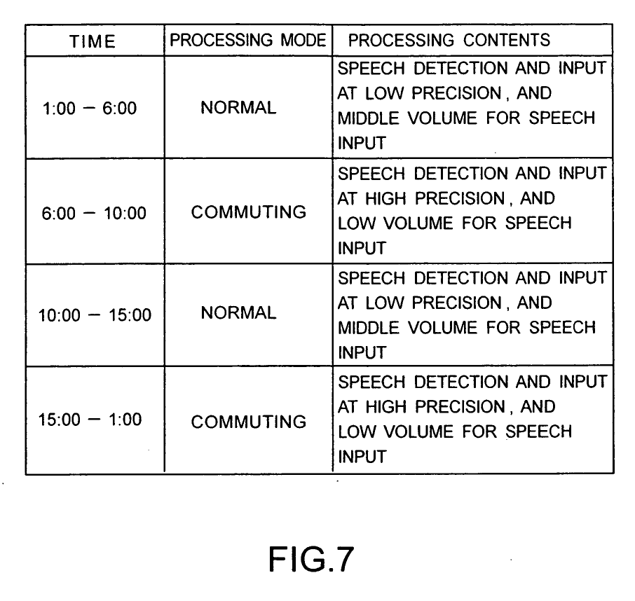

Next, the speech input system of the second embodiment of the present invention is explained. The flow chart of processing of the speech input system of the second embodiment is the same as FIG. 2. FIG. 7 shows a correspondence relationship between environment information and processing contents according to the second embodiment. As a processing mode as the environment information related to time, a “normal” mode and a “commuting” mode are selectively set. The commuting mode represents a mode to input a speech in a noisy place, such as a train or other congested area. For example, during a time not in rush hour, such as “one o'clock˜six o'clock” and “ten o'clock˜fifteen o'clock”, the “normal” mode is set to the PDA. In this case, speech detection and speech input are executed at low precision. Furthermore, middle volume for speech input is set because the surrounding situation of the user is not noisy. On the other hand, during rush hour, such as “six o'clock˜ten o'clock” and “fifteen o'clock˜one o'clock”, the “commuting” mode is set to the PDA. In this case, speech detection and speech input are executed at high precision. Furthermore, low volume for speech input is set (for example, the speech signal level lowers a little) because the surroundings of the user is noisy and the user speaks more loudly.

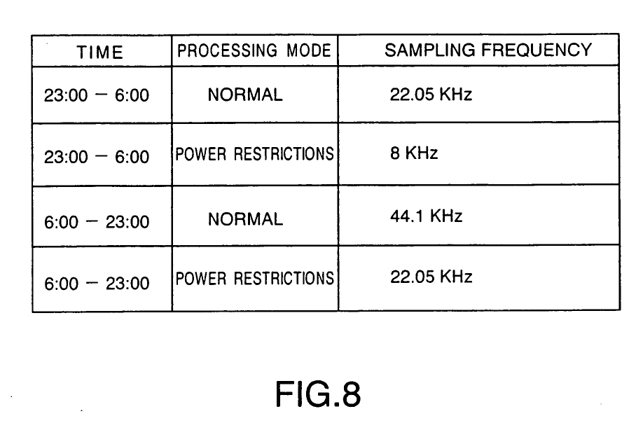

Next, the speech input system of the third embodiment of the present invention is explained. The flow chart of processing of the speech input system of the third embodiment is the same as FIG. 2. FIG. 8 shows a correspondence relationship between environment information and signal processing parameters according to the third embodiment. As a processing mode related to the environment parameter of time, a “normal” mode and a “power restrictions” mode are selectively set. As the signal processing parameter, a sampling frequency for input speech is set in correspondence with each mode related to time. Briefly, determination of processing contents is set as a signal processing parameter, and the signal processing parameter here is the sampling frequency. In the third embodiment, the sampling frequency is a discrete value as shown in FIG. 8. However, the sampling frequency may be a continuous functional value related to time. For example, in the case of the “normal” mode at ten o'clock, the sampling frequency is 44.1 KHz (CD quality) because the speech should be input at high precision. In the case of “normal” mode at twenty-four o'clock and in the case of “power restrictions” mode at ten o'clock, the sampling frequency is 22.05 KHz. In the case of power restrictions mode at twenty-four o'clock, the sampling frequency is 8 KHz (telephone quality). A method for converting the input speech to digital signals by the sampling frequency can be realized using the prior method.

As mentioned above, in the first and third embodiment, by using the environment information related to time, in the case of a daily general situation, the speech is input at high precision. On the other hand, in the case that electronic power for processing is low, or speech input of high precision is not necessary, such as at night time, speech processing of low precision is executed in order not to impose a burden on the speech input system. Furthermore, in the second embodiment, the speech is input at high precision in a noisy surrounding situation. On the other hand, the speech is input at low precision in a silent surrounding situation. Briefly, the speech processing can be executed based on the use situation.

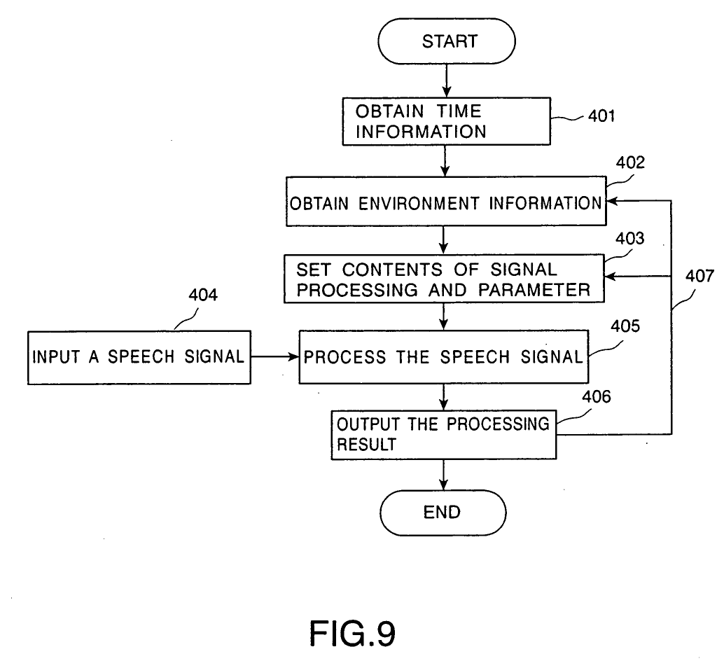

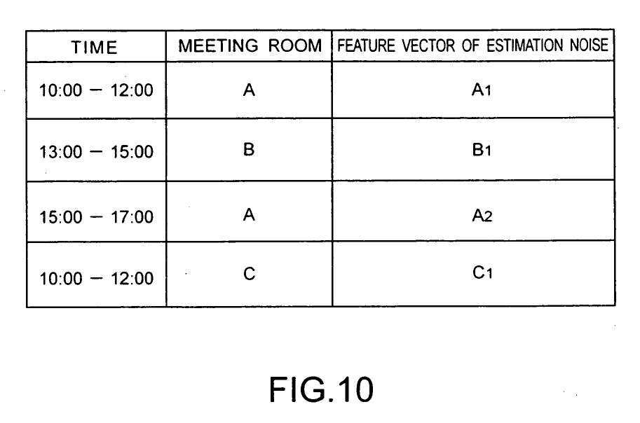

Next, the speech input system according to the fourth embodiment of the present invention is explained by referring to FIGS. 9 and 10. In the fourth embodiment, the speech input system installed into a notebook type computer (NPC) used for a company is explained as the example. In this case, the speech input system can be realized as an application program for speech processing.

The environment information represents a place in which the NPC is used in relation to time, for example, meeting rooms A, B and C. This environment information is stored in the memory unit 103 of the speech input system 101. As processing contents of the speech input system 101, a noise reduction processing is executed for the user's speech. The speech signal with reduced noise is output to the NPC and stored as the minutes of a meeting, for example. Furthermore, a signal processing parameter used for the noise reduction processing is stored in correspondence with each room as environment information. Assume that signal processing of noise reduction is executed using a spectral subtraction method (SS). The SS method is disclosed in the reference (1). In the fourth embodiment, a feature vector of estimated noise is the parameter used for signal processing. Furthermore, this feature vector of estimated noise is arbitrarily updated during non-speech intervals in the used meeting room.

FIG. 10 shows a correspondence relationship between the environment information and the parameter. This correspondence relationship is previously stored in the memory unit 103. A user inputs a use time and a meeting room name on a predetermined part of a set screen of the NPC. In this case, the noise reduction processing can be executed.

FIG. 9 is a flow chart of processing of the speech input system according to the fourth embodiment of the present invention. First, the control unit 105 obtains the present time as time information from the time measurement unit 105-1 (401). Next, the control unit 105 obtains environment information (meeting room name) related to the present time (402). Then, the control unit 105 retrieves the signal processing parameter (feature vector of estimated noise) related to the environment information from the memory unit 103, and sets the signal processing parameter in the signal processing unit 104 (403). In this case, by referring to the correspondence relationship shown in FIG. 10, if the same environment information (the same meeting room name) exists in the correspondence relationship, the feature vector of estimated vector corresponding to the same environment information is retrieved and used for signal processing. On the other hand, if the same environment information does not exist in the correspondence relationship, the control unit 105 confirms whether an empty area exists in the memory unit 103, and creates new environment information. Briefly, in this example, if a meeting room is used on one occasion for the first time, an area to store new environment information and new parameters is assigned to the memory unit 103. In this case, an initial value of the new parameter is determined by an average value of all estimated values or a present value for initial value. Furthermore, predetermined processing may be assigned without creating the new parameter.

In this way, after the processing parameter is set in the signal processing unit 104, the noise reduction processing is executed for the input speech (404) and noise estimation is executed during non-speech use of the meeting room (405). The processed signal, as the processing result, is output to the NPC (406). After the signal processing is completed, the processing parameter is updated by the estimated noise and stored in correspondence with the environment information (meeting room name) in memory unit 103. In this case, the processed signal may be further processed using the estimated parameter.

In the fourth embodiment, in the case of updating the environment information and the parameter, a new memory area is assigned whenever a new condition is decided. Furthermore, information is updated whenever the signal processing is executed. The new condition can be decided by the time, the meeting room, or the parameter. Concretely, after speech processing is executed in new meeting room at a new time, a new parameter of estimated noise is calculated. In the parameter already stored in the correspondence relationship, the parameter near the new parameter is extracted and commonly used as the new parameter. For example, in FIG. 10, as to the feature vectors A₁ and A₂, each time is different but the meeting rooms are the same. Accordingly, if the feature vector A₁ is sufficiently near the feature vector A₂, the feature vector A₁ may be commonly used for both times, instead of the feature vector A₂ being used for the second time.

Next, the speech input system of the fifth embodiment of the present invention is explained. As in the fourth embodiment, the speech input system is installed into the NPC. In the fifth embodiment, as a specific feature different from the fourth embodiment, a schedule table is stored in the NPC and environment information is extracted from the schedule table. In the schedule table, a time, a meeting room name, and another information (For example, parameter) are correspondingly stored. By using the schedule table, a meeting room to be used in correspondence with the use time is determined, and the parameter corresponding to the meeting room is retrieved from the memory unit 103. Accordingly, noise reduction processing can be suitably executed using the parameter. For example, assume that the user utilized the meeting room A today and will utilize the meeting room A at different time tomorrow. In this case, at the different time tomorrow, the speech signal processing is automatically executed using the noise reduction parameter of the meeting room A.

Next, the speech input system of the sixth embodiment of the present invention is explained. The example used for the sixth embodiment is the same as used in the fifth embodiment. A specific feature of the sixth embodiment, different from the fifth embodiment, is that the schedule includes information about whom the user meets with by scheduled time. Briefly, in the sixth embodiment, the speech input fitted for the other person can be automatically executed at the time when the user meets the other person. In the speech recognition processing, the speaker is identified as the person with whom the user meets and a recognition ratio can be improved using the person's individual information. If this event (the user's meeting with a person) is not stored in the schedule, speech recognition processing for unspecified persons may be executed using representative user information (default information). This signal processing includes a noise reduction and a speech emphasis fitted for the speaker. This signal processing method can be realized by prior method generally known and used.

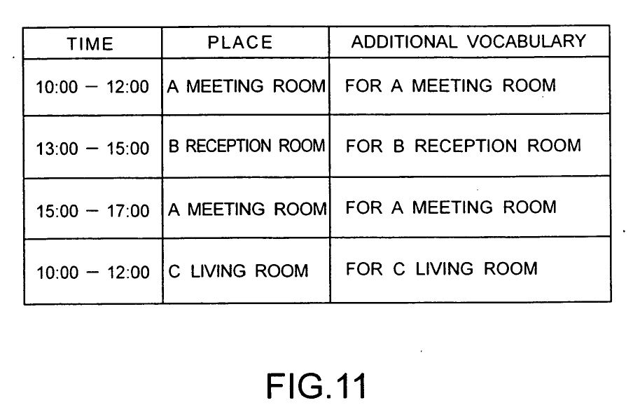

Next, the speech input system of the seventh embodiment of the present invention is explained by referring to FIG. 11. An example used for the seventh embodiment is the same as the fifth embodiment. As a specific feature of the seventh embodiment different from the fifth embodiment, the signal processing includes the speech recognition. The speech recognition method is disclosed in many prior documents such as the reference (4). For example, the speech recognition using HMM (Hidden Markov Model) disclosed in the reference (4) is used. Vocabularies as objects of the speech recognition are general vocabularies previously set. Furthermore, additional vocabularies related to place are used as the processing parameter. In this case, the additional vocabularies related to place are previously registered. However, the user or a high level system of the speech input system may arbitrarily register such additional vocabularies.

FIG. 11 shows a correspondence relationship between the environment information (place) and the parameter (additional vocabulary). A flow chart of processing of the seventh embodiment is the same as FIG. 2. Concretely, the environment information related to the measured time is obtained and the additional vocabulary corresponding to the environment information (meeting room) is retrieved from the correspondence relationship shown in FIG. 11. The speech recognition is executed using the general recognition vocabularies and the additional vocabularies. The recognition result is output from the speech input system.

Next, the speech input system of the eighth embodiment of the present invention is explained. An example used for the eighth embodiment is same as the seventh embodiment (including the speech recognition). As a specific feature of the eighth embodiment different from the seventh embodiment, the speech input system can send and receive information through the communication unit 102, and another speech input system exists in the communication path of the speech input system. A communication path between speech input systems can be realized by existing communication techniques between devices such as Local Area Network (LAN) and Bluetooth. In this case, detection of another communication device, establishment of a communication path, and the actual communication method, are accompanied with the existing communication techniques.

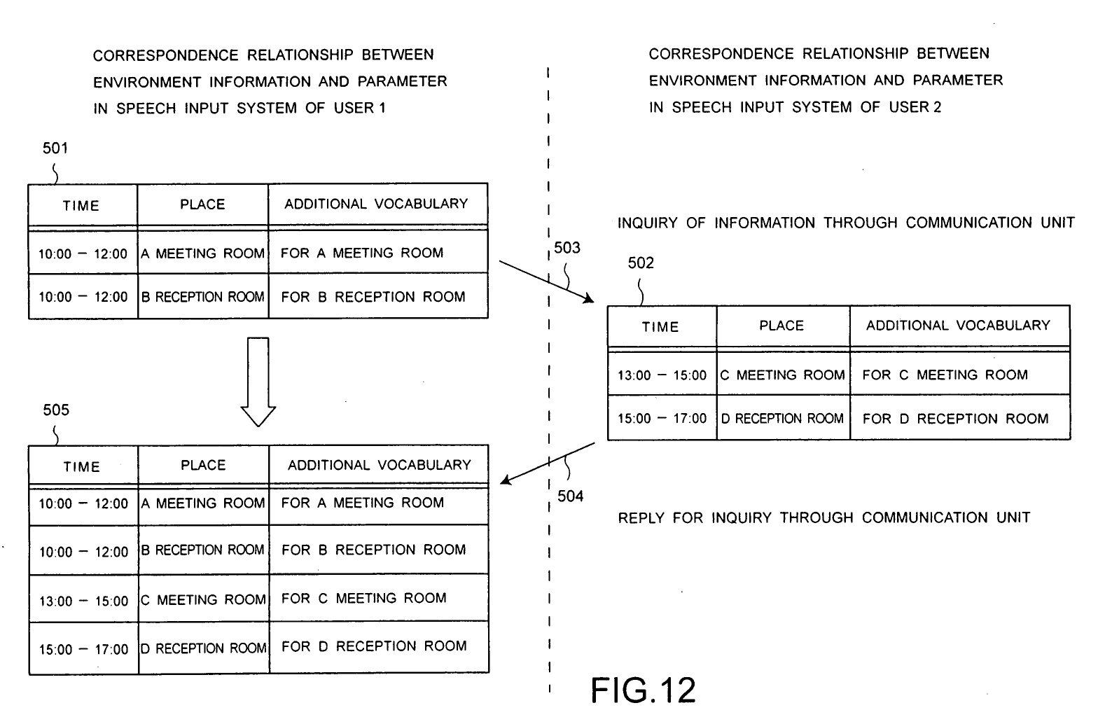

FIG. 12 is a schematic diagram of information transmission between speech input systems through the communication unit 102. As mentioned above, assume that two speech input systems which communicate with each other through the communication path, exist. One is the speech input system of user 1 and the other is the speech input system of user 2. Each speech input system includes the above-mentioned environment information (place) and corresponding parameter (additional vocabulary). Concretely, in FIG. 12, the speech input system of user 1 stores a correspondence relationship 501 between the place and the additional vocabulary, and the speech input system of user 2 stores a correspondence relationship 502 between the place and the additional vocabulary. In this case, the additional vocabulary, as a processing parameter used for the signal processing unit 104, is stored in the memory unit 103 of each speech input system.

When the speech input system of user 1 retrieves environment information related to the measured time, the speech input system sends an inquiry of environment information to another speech input system through a communication path (503). In response to the inquiry of environment information, the speech input system of user 2 sends a correspondence relationship between environment information (place) and additional vocabulary as a reply to the inquiry to the speech input system of user 1 (504). The speech input system of user 1 receives the correspondence relationship 502 of the speech input system of user 2. As a result, a correspondence relationship 505 is created from the correspondence relationship 501 of the speech input system of user 1 and the correspondence relationship 502 of the speech input system of user 2. The speech input system of user 1 can utilize the correspondence relationship between the environment information and the additional vocabulary not stored before within the system of user 1.

Briefly, if a user enters a new surrounding situation different from his or her usual surrounding situation, a speech input system of the user can utilize information of another speech input system of another user who already experienced the new surrounding situation. Accordingly, speech processing can be executed based on the new surrounding situation. In this case, by mutually transmitting the inquiry (503) and the reply (504) of information through the communication unit, two speech input systems may respectively obtain a sum of each correspondence relationship between the environment information and the additional vocabulary of each speech input system. In this way, two speech input systems can jointly use the correspondence relationship between the environment information and the additional relationship of each speech input system.

In the eighth embodiment, after the present time is measured at the start of processing, the inquiry and the reply of information are transmitted between two speech input systems. However, before the present time is measured, the inquiry and the reply of information may be transmitted between two speech input systems. Furthermore, in the eighth embodiment, all information of correspondence relationship between the environment information and the additional vocabulary is received from another speech input system. However, the correspondence relationship related to the measured time is only received from another speech input system. Furthermore, if the speech input system stores information not to be provided to another speech input system or a difference of information between the speech input system and another input system exists, a method for updating information (For example, overwrite or non-change) may be controlled by a user or a high level system of the speech input system.

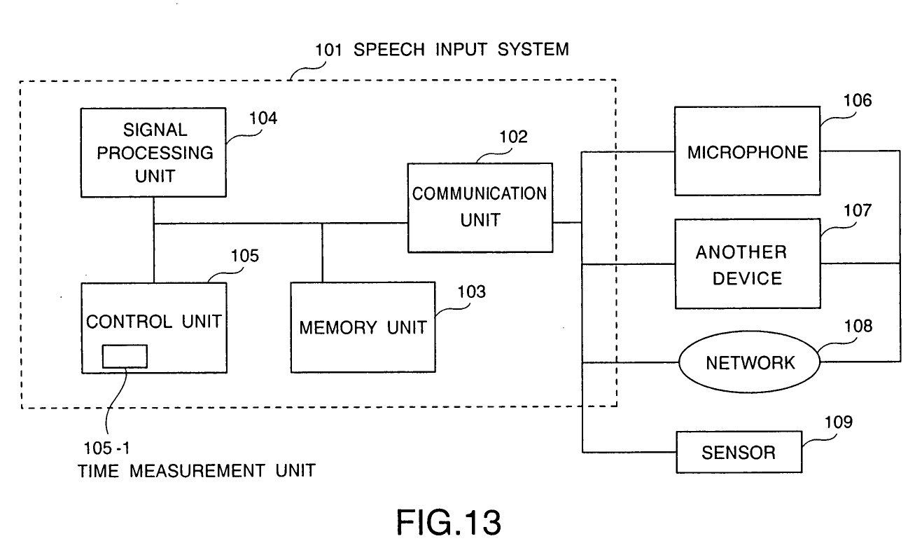

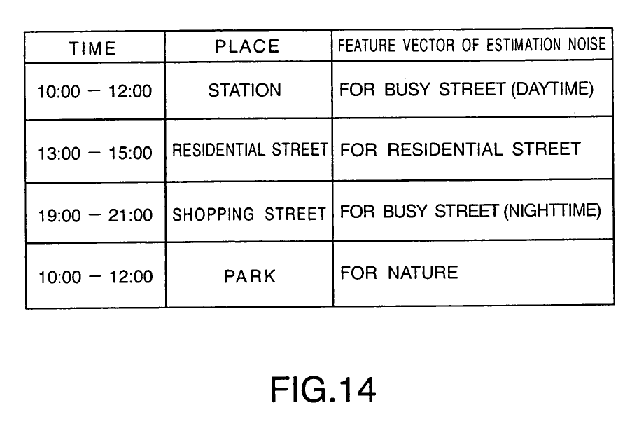

Next, the speech input system of the ninth embodiment of the present invention is explained by referring to FIGS. 13 and 14. FIG. 13 is a block diagram of the speech input system according to the ninth embodiment. A specific feature of FIG. 13 different from FIG. 1 is that information is input from a sensor 109 to the communication unit 102. As shown in FIG. 13, the speech input system 101 can receive sensor information, except for the speech signal, from the sensor 109. This sensor 109 may be located in the speech input system. For example, sensor information from the sensor 109 may be the present location information obtained from a global positioning system (GPS) and map information. In this case, accurate time information can be simultaneously obtained from GPS. Briefly, the control unit 105 decides a category of place where the user is currently located from the present location information and the map information. This decision result is regarded as sensor information. As a decision method, for example, the category of place can be determined by a landmark near the present location or a building from the map information. Furthermore, the signal processing is noise reduction and the parameter is a feature vector of estimated noise for the use situation.

FIG. 14 shows a correspondence relationship between the environment information (place) and the signal processing parameter (feature vector of estimation noise) in correspondence with time information stored in the memory unit 103. This correspondence relationship is previously stored in the memory unit 103 by the user's operation or the high level system. However, if the processing parameter necessary for the environment information related to the time is not stored in the memory unit 103, the environment information and the processing parameter of the speech input system can be updated using information from the sensor 109.

A flow chart of processing of the ninth embodiment is the same as FIG. 2. However, in the ninth embodiment, sensor information (For example, the present location information) with time information is obtained. If a combination of the time information and the present location information is stored in the correspondence relationship (FIG. 14) of the memory unit 103, the feature vector of estimation noise corresponding to the combination is read from the memory unit 103. The signal processing unit 104 executes the noise reduction processing by using the feature vector. For example, if the user is located in a station at eleven o'clock, the feature vector of estimated noise for a busy street (daytime) is obtained as shown in FIG. 14. By using a noise reduction method, such as spectral subtraction method (SS), and using the feature vector of estimation noise as the parameter, the signal processing can be quickly executed based on the surrounding situation. If the same combination (condition) is not stored in the correspondence relationship, new conditions may be set or another condition stored in the correspondence relationship may be representatively used. For example, if the user is located in the station at nine o'clock, the same condition is not stored in FIG. 14. However, a combination of time “10:00-12:00” and a place “station” may be representatively used because the time condition “nine o'clock” is near time “10:00” of the combination. This representative method is arbitrarily selected based on application use.

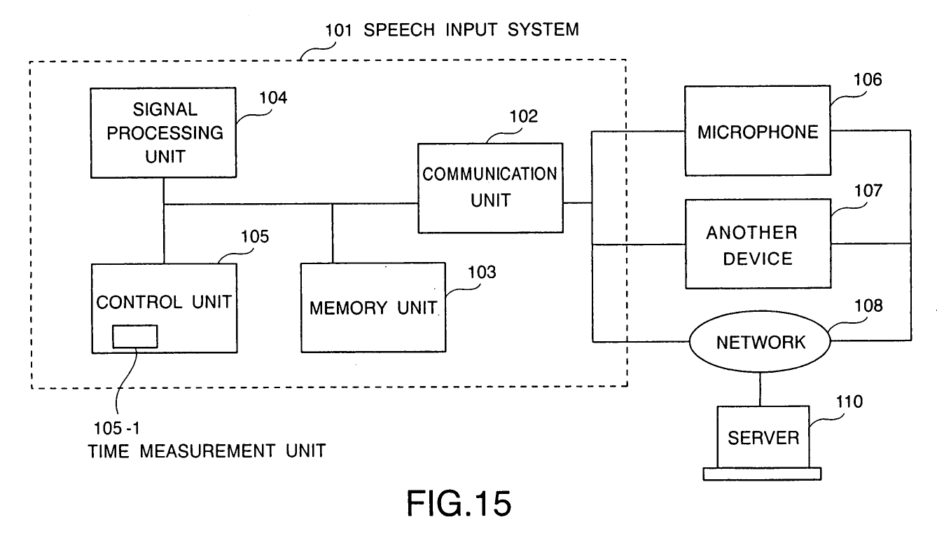

Next, the speech input system of the tenth embodiment of the present invention is explained. In the tenth embodiment, a part of memory function of the speech input system is commonly used by another speech input system. FIG. 15 is a block diagram of the speech input system according to the tenth embodiment. A specific feature of FIG. 15 different from FIG. 1 is a server 110 connected to the network 108 in order to commonly use and share data. For example, in the case of using a plurality of devices (For example, the PDA) each including the speech input system in a company, environment information related to time is collectively stored in the server 110 and commonly used as employee information of the company. In this way, by holding the environment information in common, even if a device of an employee does not receive the environment information from another device of another employee, each employee can obtain the environment information and suitably input his/her speech based on the environment information related to time in anywhere of the company.

Next, the speech input system of the eleventh embodiment of the present invention is explained. In the eleventh embodiment, a part of the signal processing function of the speech input system is commonly used by another speech input system. Concretely, a server collectively executes each signal processing by using the processing parameter for common use. By holding the processing parameter in common, if a plurality of persons respectively locate in the same place (For example, a room) at the same time, the use situation of each person is the same. Briefly, the processing parameter related to the use situation is the same for a plurality of speech input systems of each user. Accordingly, in the case of inputting and processing the speech, each person can easily receive a common service as the same processing result.

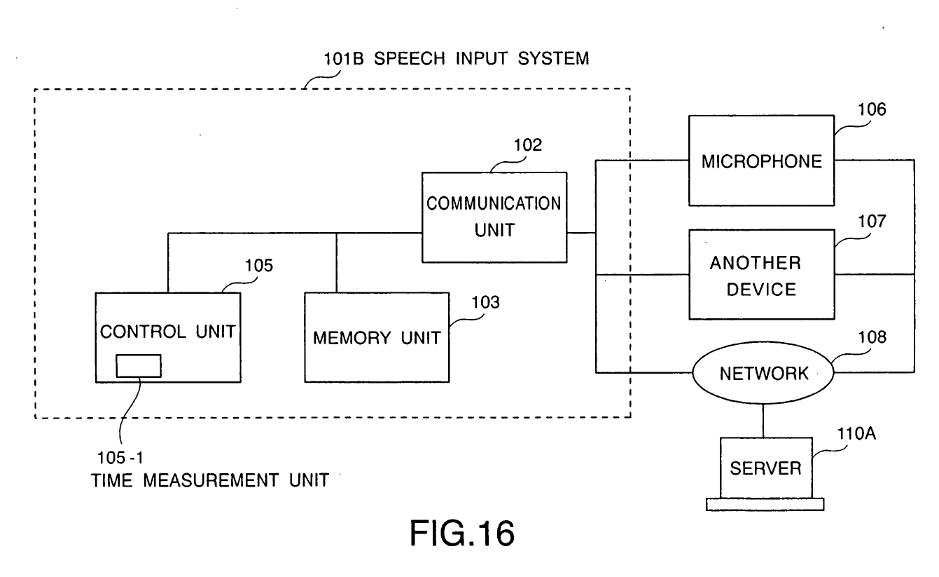

FIG. 16 is a block diagram of the speech input system according to the eleventh embodiment. In FIG. 16, a server 110A to collectively execute the signal processing is connected to the network 108 such as the Internet, and the speech input system 101B does not include a signal processing unit. In this component, when a speech is input from the microphone 106 to the speech input system 101B, the speech data is temporarily stored in the memory unit 103 through the communication unit 102. The speech data is transferred to the server 110A through the network 108 by the control unit 105. The server 110A executes the signal processing for the speech data by using the processing parameter related to time, and sends the processing result data to the speech input system 101B through the network 108. The processing result data is stored in a predetermined area of the memory unit 103 or in a memory means of a main body unit (not shown in FIG. 16) of a terminal apparatus including the speech input system 101B.

The terminal apparatus including the speech input system of the present invention can be applied to a speaker identification apparatus using the signal processing. Concretely, it is useful that the speech input system of the present invention is used for person identification of a portable terminal.

As mention-above, in the present invention, environment information related to time information is retrieved and the processing of input speech is controlled using the environment information. Accordingly, the signal processing based on the surrounding situation can be executed without the user's operation or control of the high level system of the speech input system.

For embodiments of the present invention, the processing of the present invention can be accomplished by a computer-executable program, and this program can be realized in a computer-readable memory device.

In embodiments of the present invention, a memory device, such as a magnetic disk, a floppy disk, a hard disk, an optical disk (CD-ROM, CD-R, DVD, and so on), an optical magnetic disk (MD, and so on) can be used to store instructions for causing a processor or a computer to perform the processes described above.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one device. In the case that the processing of the embodiments is executed by a plurality of memory devices, a plurality of memory devices may be included in the memory device. The components of the device may be arbitrarily composed.

In embodiments of the present invention, the computer executes each processing stage of the embodiments according to the program stored in the memory device. The computer may be one apparatus such as a personal computer or a system in which a plurality of processing apparatuses are connected through the network. Furthermore, in the present invention, the computer is not limited to a personal computer. Those skilled in the art will appreciate that a computer includes a processing unit in an information processor, a microcomputer, and so on. In short, the equipment and the apparatus that can execute the functions in embodiments of the present invention using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. An speech input apparatus, comprising:
a receiving unit configured to receive a speech signal, a signal processing unit configured to process the speech signal;
a memory configured to store environment information related to time;
a time measurement unit configured to measure a time; and
a control unit configured to retrieve environment information related to the time from said memory, and to control the processing of said signal processing unit in accordance with the retrieved environment information.

2. The speech input apparatus according to claim 1,
wherein said memory stores a parameter related to a specified time, and the parameter is used in the processing of said signal processing unit.

3. The speech input apparatus according to claim 2,
wherein said control unit retrieves the parameter related to the specified time from said memory, and controls the processing of said signal processing unit in accordance with the retrieved parameter.

4. The speech input apparatus according to claim 3,
wherein said control unit updates the environment information and the parameter related to the time in said memory by referring to the processing result of said signal processing unit.

5. The speech input apparatus according to claim 1,
wherein the environment information is place information or personal information.

6. The speech input apparatus according to claim 1,
wherein the environment information is mode information representing a normal mode or a special mode.

7. The speech input apparatus according to claim 1,
wherein the parameter represents the precision of speech detection and input signal level.

8. The speech input apparatus according to claim 1,
wherein the parameter is a feature vector to suppress noise in the input speech.

9. The speech input apparatus according to claim 1,
wherein said memory stores vocabularies related to time, and the vocabularies are used for speech recognition.

10. The speech input apparatus according to claim 9,
wherein said control unit retrieves the vocabularies related to time from said memory, and
wherein said signal processing unit recognizes the input speech using the retrieved vocabularies.

11. The speech input apparatus according to claim 2,
further comprising a communication unit configured to send a request for information related to time to another speech input apparatus, and to receive environment information and parameter from said another speech input apparatus in response.

12. The speech input apparatus according to claim 11,
wherein said control unit updates the environment information and the parameter in said memory by referring to the received environment information and the received parameter.

13. The speech input apparatus according to claim 2,
further comprising a sensor configured to input sensor information other than a speech signal, and
wherein said control unit updates the environment information and the parameter in said memory by referring to the sensor information.

14. The speech input apparatus according to claim 11,
wherein said memory is located in a server outside the speech input apparatus, and is commonly used by multiple speech input apparatus.

15. The speech input apparatus according to claim 11,
wherein the processing by said signal processing unit is executed by a server outside the speech input apparatus.

16. The speech input apparatus according to claim 11,
wherein a memory area storing the environment information related to time exists outside the speech input apparatus, and
wherein said memory stores address information related to time to read the environment information from the memory area.

17. The speech input apparatus according to claim 16,
wherein said control unit retrieves the address information related to time from said memory, receives the environment information corresponding to the address information from the memory area through said communication unit, and controls the processing of said signal processing unit in accordance with the received environment information.

18. The speech input apparatus according to claim 1,
wherein said receiving unit, said signal processing unit, said memory, said time measurement unit, and said control unit are installed into a portable terminal.

19. A method for inputting a speech, comprising:
storing environment information related to time in a memory;
receiving a speech signal;
measuring a time;
retrieving environment information related to the time from the memory;
determining a processing method to process the speech signal in accordance with the retrieved environment information; and
executing the processing method for the speech signal.

20. A computer program product, comprising:
a computer readable program code for causing a computer to input a speech, said computer readable program code comprising:
a first program code to store environment information related to time in a memory;
a second program code to receive a speech signal;
a third program code to measure a time;
a fourth program code to retrieve environment information related to the time from the memory;
a fifth program code to determine a processing method to process the speech signal in accordance with the retrieved environment information; and
a sixth program code to execute the processing method for the speech signal.
